(19) United States
(12) Patent Application Publication
(10) Pub. No.: US 2026/0113745 A1
(43) Pub. Date: Apr. 23, 2026

(54) VARIABLE THROUGHPUT WIDEBAND SCHEDULING

(71) Applicant: QUALCOMM Incorporated, San Diego, CA (US)

(72) Inventors: Diana MAAMARI, San Diego, CA (US); Gabi SARKIS, San Diego, CA (US); Jing SUN, San Diego, CA (US); Jing JIANG, San Diego, CA (US)

(21) Appl. No.: 18/921,924

(22) Filed: Oct. 21, 2024

(51) Int. Cl. H04W 72/1273; H04W 72/0446; H04W 72/0453

(52) U.S. Cl. CPC H04W 72/1273; H04W 72/0446; H04W 72/0453

(57) ABSTRACT

Various aspects relate generally to wideband scheduling with a variable throughput to improve energy efficiency (for example, reduce power consumption) for a user equipment (UE) scheduled to receive one or more high throughput data transmissions. Some aspects more specifically relate to a UE receiving information that configures variable throughput scheduling for one or more downlink transmissions with a peak throughput for an initial time period in one or more scheduling intervals, followed by transmissions at a reduced throughput for remaining time periods in the one or more scheduling intervals. For example, in some aspects, the information that configures the variable throughput wideband scheduling may include a downlink control information (DCI) message that indicates one or more slots where a wideband downlink transmission is scheduled and reduced throughput periods or gaps that allow the UE to avoid ramping up to a highest power state.

### FIELD OF THE DISCLOSURE

Aspects of the present disclosure generally relate to wireless communication and specifically relate to techniques, apparatuses, and methods associated with variable throughput wideband scheduling.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Wideband scheduling may be used in a wireless communication system to meet a demand for high data rates and improved user experience. With high data rate applications such as video streaming, online gaming, and extended reality (XR) becoming more prevalent, wideband scheduling may be used to provide fast and reliable wireless data transmission. For example, in contrast to narrowband scheduling that allocates resources within a relatively limited frequency band (for example, a bandwidth part (BWP) that spans only a portion of a carrier bandwidth), wideband scheduling may be used to allocate a larger frequency spectrum and thereby enable a higher throughput and/or a lower latency. In this way, wideband scheduling may support the quality of service (QoS) or quality of experience (QoE) demands associated with data-intensive applications, may enhance spectral efficiency and network capacity, and/or may accommodate more users and/or devices within the same bandwidth.

### SUMMARY

Some aspects described herein relate to a user equipment (UE) for wireless communication. The UE may include a processing system that includes one or more processors and one or more memories coupled with the one or more processors. The processing system may be configured to cause the UE to receive information that configures variable throughput scheduling for one or more downlink transmissions, wherein the information that configures the variable throughput scheduling indicates a peak throughput for an initial time period and a reduced throughput for a remaining time period in one or more scheduling intervals. The processing system may be configured to cause the UE to receive the one or more downlink transmissions in the one or more scheduling intervals according to the peak throughput for the initial time periods and the reduced throughput for the remaining time periods in the one or more scheduling intervals.

Some aspects described herein relate to a network node for wireless communication. The network node may include a processing system that includes one or more processors and one or more memories coupled with the one or more processors. The processing system may be configured to cause the network node to transmit information that configures variable throughput scheduling for one or more downlink transmissions, wherein the information that configures the variable throughput scheduling indicates a peak throughput for an initial time period and a reduced throughput for a remaining time period in one or more scheduling intervals. The processing system may be configured to cause the network node to transmit the one or more downlink transmissions in the one or more scheduling intervals according to the peak throughput for the initial time periods and the reduced throughput for the remaining time periods in the one or more scheduling intervals.

Some aspects described herein relate to a method of wireless communication performed by a UE. The method may include receiving information that configures variable throughput scheduling for one or more downlink transmissions, wherein the information that configures the variable throughput scheduling indicates a peak throughput for an initial time period and a reduced throughput for a remaining time period in one or more scheduling intervals. The method may include receiving the one or more downlink transmissions in the one or more scheduling intervals according to the peak throughput for the initial time periods and the reduced throughput for the remaining time periods in the one or more scheduling intervals.

Some aspects described herein relate to a method of wireless communication performed by a network node. The method may include transmitting information that configures variable throughput scheduling for one or more downlink transmissions, wherein the information that configures the variable throughput scheduling indicates a peak throughput for an initial time period and a reduced throughput for a remaining time period in one or more scheduling intervals. The method may include transmitting the one or more downlink transmissions in the one or more scheduling intervals according to the peak throughput for the initial time periods and the reduced throughput for the remaining time periods in the one or more scheduling intervals.

Some aspects described herein relate to a non-transitory computer-readable medium that stores a set of instructions for wireless communication by a UE. The set of instructions, when executed by one or more processors of the UE, may cause the UE to receive information that configures variable throughput scheduling for one or more downlink transmissions, wherein the information that configures the variable throughput scheduling indicates a peak throughput for an initial time period and a reduced throughput for a remaining time period in one or more scheduling intervals. The set of instructions, when executed by one or more processors of the UE, may cause the UE to receive the one or more downlink transmissions in the one or more scheduling intervals according to the peak throughput for the initial time periods and the reduced throughput for the remaining time periods in the one or more scheduling intervals.

Some aspects described herein relate to a non-transitory computer-readable medium that stores a set of instructions for wireless communication by a network node. The set of instructions, when executed by one or more processors of the network node, may cause the network node to transmit information that configures variable throughput scheduling for one or more downlink transmissions, wherein the information that configures the variable throughput scheduling indicates a peak throughput for an initial time period and a reduced throughput for a remaining time period in one or more scheduling intervals. The set of instructions, when executed by one or more processors of the network node, may cause the network node to transmit the one or more downlink transmissions in the one or more scheduling intervals according to the peak throughput for the initial time periods and the reduced throughput for the remaining time periods in the one or more scheduling intervals.

Some aspects described herein relate to an apparatus for wireless communication. The apparatus may include means for receiving information that configures variable throughput scheduling for one or more downlink transmissions, wherein the information that configures the variable throughput scheduling indicates a peak throughput for an initial time period and a reduced throughput for a remaining time period in one or more scheduling intervals. The apparatus may include means for receiving the one or more downlink transmissions in the one or more scheduling intervals according to the peak throughput for the initial time periods and the reduced throughput for the remaining time periods in the one or more scheduling intervals.

Some aspects described herein relate to an apparatus for wireless communication. The apparatus may include means for transmitting information that configures variable throughput scheduling for one or more downlink transmissions, wherein the information that configures the variable throughput scheduling indicates a peak throughput for an initial time period and a reduced throughput for a remaining time period in one or more scheduling intervals. The apparatus may include means for transmitting the one or more downlink transmissions in the one or more scheduling intervals according to the peak throughput for the initial time periods and the reduced throughput for the remaining time periods in the one or more scheduling intervals.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example of a bandwidth part in accordance with the present disclosure.

FIG. 4 is a diagram illustrating examples of narrowband scheduling and wideband scheduling in accordance with the present disclosure.

FIG. 5 is a diagram illustrating examples of operating modes associated with a UE in accordance with the present disclosure.

FIGS. 6A-6B are diagrams illustrating examples associated with variable throughput wideband scheduling in accordance with the present disclosure.

FIG. 7 is a flowchart illustrating an example process performed, for example, at a UE or an apparatus of a UE that supports wireless communication in accordance with the present disclosure.

FIG. 8 is a flowchart illustrating an example process performed, for example, at a network node or an apparatus of a network node that supports wireless communication in accordance with the present disclosure.

FIG. 9 is a diagram of an example apparatus for wireless communication that supports wireless communication in accordance with the present disclosure.

FIG. 10 is a diagram of an example apparatus for wireless communication that supports in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Narrowband scheduling and wideband scheduling modes are generally used in wireless networks to support different use cases and/or performance requirements. For example, narrowband scheduling is used to allocate resources within a limited frequency band, which reduces the complexity of resource allocation and is particularly suitable in scenarios where devices have predictable and/or consistent traffic patterns. By leveraging smaller bandwidths, such as a portion of a carrier bandwidth or a limited quantity of component carriers, narrowband scheduling can optimize energy efficiency and reduce interference. On the other hand, wideband scheduling utilizes the broader frequency spectrum that may be available to a network node in order to support high data rate applications, such as video streaming and extended reality (XR). By utilizing a larger bandwidth than narrowband scheduling, wideband scheduling can achieve higher throughputs, better spectral efficiency, and a more flexible and dynamic resource allocation to efficiently manage varying traffic loads and/or user demands.

However, wideband scheduling introduces various challenges, including increased power consumption. For example, when a user equipment (UE) is scheduled in a wideband mode, the UE may transition to a high power state that enables the UE to process a wideband data transmission faster and thereby reduce latency and increase throughput (for example, allowing additional wideband data transmissions to be scheduled after the UE has provided feedback indicating that the previous wideband data transmission has been processed). For example, to enable faster data processing, the UE may transition an internal baseband clock to a higher frequency and increase a supply voltage to support the higher clock frequency, which can lead to a quadratic increase in power consumption and/or potential leakage of current. However, in some cases, the network node may not schedule the UE with sustained peak throughput. For example, applications such as XR are often associated with traffic that arrives in bursts, where a large data volume is transmitted in a short time period that is followed by a time period with little or no traffic. In such cases, the UE may not need to ramp up to the highest power state corresponding to wideband scheduling. However, wireless networks lack the flexibility to inform the UE about less demanding traffic periods where the UE can operate in a reduced power state relative to a highest power state used for wideband scheduling.

Various aspects relate generally to wideband scheduling with a variable throughput to improve energy efficiency (for example, reduce power consumption) for a UE scheduled to receive one or more high throughput data transmissions. Some aspects more specifically relate to a UE receiving information that configures variable throughput scheduling for one or more wideband downlink transmissions. More specifically, each of the downlink transmissions may be scheduled to occur within an initial time period in each of one or more scheduling intervals. During these initial time periods, the wideband downlink transmissions may be transmitted in accordance with a high or peak throughput, and the UE may be configured to ramp up an internal baseband clock and/or increase a supply voltage, thereby increasing power consumption, to allow for decoding the wideband downlink transmissions. Following the initial time period in each scheduling interval is a gap or remaining time period associated with no or reduced downlink transmissions or otherwise associated with a low or reduced throughput. During these gaps or remaining time periods, the UE may be configured to reduce the internal baseband clock and/or decrease the supply voltage, thereby reducing power consumption, given that the UE does not expect to receive any wideband or high throughput downlink transmissions. For example, in some aspects, the information that configures the variable throughput wideband scheduling may include a downlink control information (DCI) message that indicates one or more slots where a wideband or high throughput downlink transmission is scheduled and one or more slots associated with no or low throughput state.

In some aspects, to configure variable throughput wideband scheduling, a network node may schedule wideband data transmissions using a transport block over multiple segments, also known as transport block over multiple slots (TBOMS), signaling framework and/or a fluid start and length indicator value (SLIV). For example, the network node may transmit, and the UE may receive, information that configures a peak throughput for an initial time period and a reduced throughput for a remaining time period in a scheduling interval. For example, the UE may receive a DCI message that indicates one repetition and multiple slots for a downlink transmission associated with a frequency domain resource allocation (FDRA) and/or SLIV that may vary over the multiple slots. In some aspects, the initial peak throughput slot(s) may be followed by one or more slots with a zero resource block (RB) allocation, representing a period of reduced throughput. Additionally or alternatively, one or more slots associated with the reduced throughput may be indicated according to a zero SLIV. Additionally or alternatively, the variable throughput wideband scheduling may be configured using a single DCI to schedule multiple downlink data transmissions. Furthermore, to provide gaps or reduced throughput periods between peak throughput periods, the DCI can indicate a varied FDRA for different physical downlink shared channels (PDSCHs) across consecutive slots. For example, one or more slots may have a non-zero RB allocation while other slots may have a zero RB allocation. Additionally or alternatively, a time domain resource allocation (TDRA) table can indicate downlink data transmissions in consecutive slots by configuring a SLIV, a mapping type, and/or a scheduling offset for each downlink data transmission, where the SLIV may be zero for downlink data transmissions following a wideband downlink data transmission. Alternatively, in some aspects, the TDRA may include a skipping indication for a wideband data transmission to indicate a time period or a quantity of slots that will not contain downlink data. In some aspects, a feedback timeline for indicating an acknowledgement (ACK) or negative acknowledgment (NACK) may be aligned from the last symbol of the last scheduled downlink data transmission.

Particular aspects of the subject matter described in this disclosure can be implemented to realize one or more of the following potential advantages. In some examples, by configuring a UE to operate initially in accordance with a peak throughput and subsequently in accordance with a reduced throughput, the described techniques may extend the time that the UE has to process a wideband downlink data transmission and thereby set a baseband clock and supply voltage at a reduced level (below the maximum level typically associated with wideband scheduling). In this way, the UE may dynamically adjust a power state, aligning an operational state with actual transmission schedules, thereby reducing power consumption when the UE will not be scheduled with sustained peak (for example, wideband) throughput.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

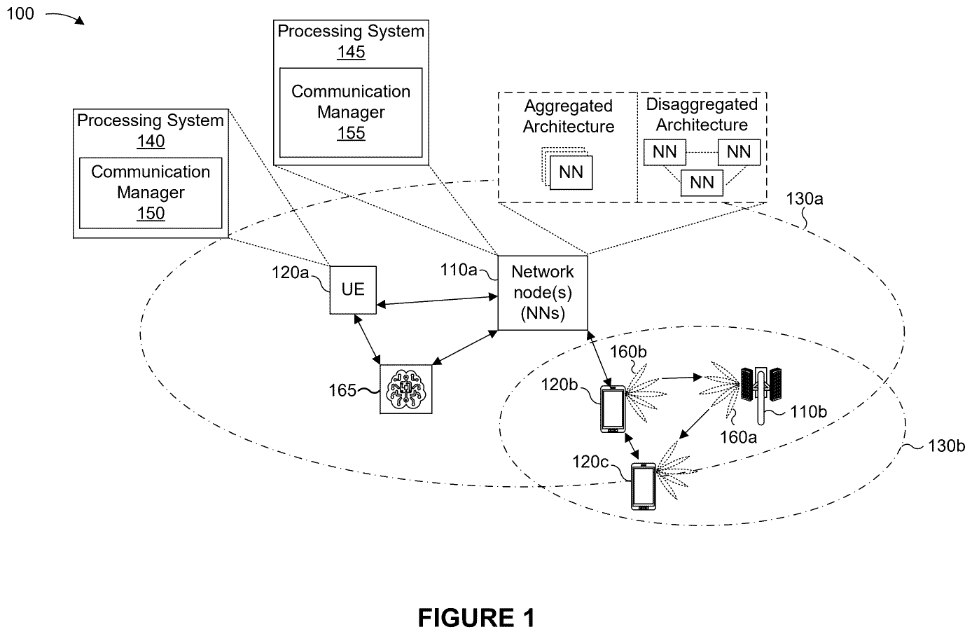

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1,and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

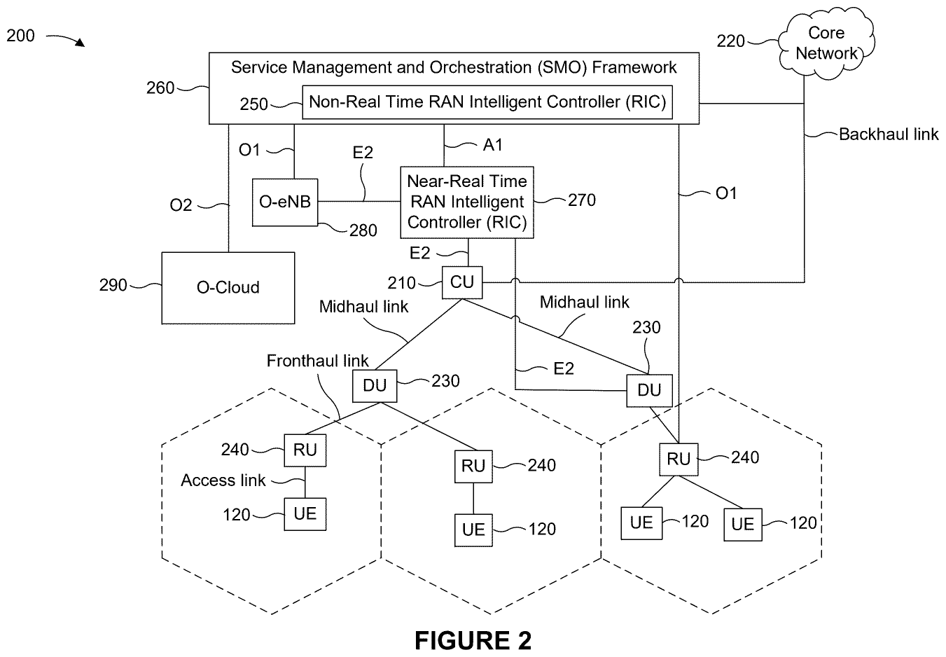

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As indicated above, a BWP may be configured as a subset or a part of a total or full component carrier bandwidth and generally forms or encompasses a set of contiguous RBs within the full component carrier bandwidth. In other words, within the carrier bandwidth, a BWP starts at a specifically configured RB and may span a specific set of consecutive RBs. Each BWP may be associated with its own numerology (indicating an SCS and CP). A UE 120 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications. Accordingly, in some examples, a UE 120 may be configured with one or more BWPs or other suitable FDRAs with a limited bandwidth in a narrowband scheduling mode, and may be configured to communicate using multiple BWPs, a larger bandwidth, or the full component carrier bandwidth in a wideband scheduling mode (for example, to enable a high throughput).

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive information that configures variable throughput scheduling for one or more downlink transmissions, wherein the information that configures the variable throughput scheduling indicates a peak throughput for an initial time period and a reduced throughput for a remaining time period in one or more scheduling intervals; and receive the one or more downlink transmissions in the one or more scheduling intervals according to the peak throughput for the initial time periods and the reduced throughput for the remaining time periods in the one or more scheduling intervals. Additionally, or alternatively, the communication manager 150 may perform one or more other operations described herein.

In some aspects, the network node 110 may include a communication manager 155. As described in more detail elsewhere herein, the communication manager 155 may transmit information that configures variable throughput scheduling for one or more downlink transmissions, wherein the information that configures the variable throughput scheduling indicates a peak throughput for an initial time period and a reduced throughput for a remaining time period in one or more scheduling intervals; and transmit the one or more downlink transmissions in the one or more scheduling intervals according to the peak throughput for the initial time periods and the reduced throughput for the remaining time periods in the one or more scheduling intervals. Additionally, or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

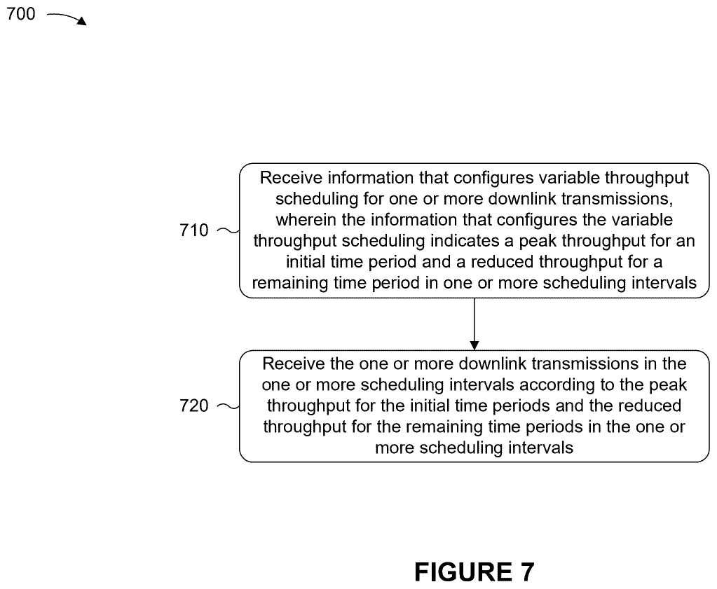

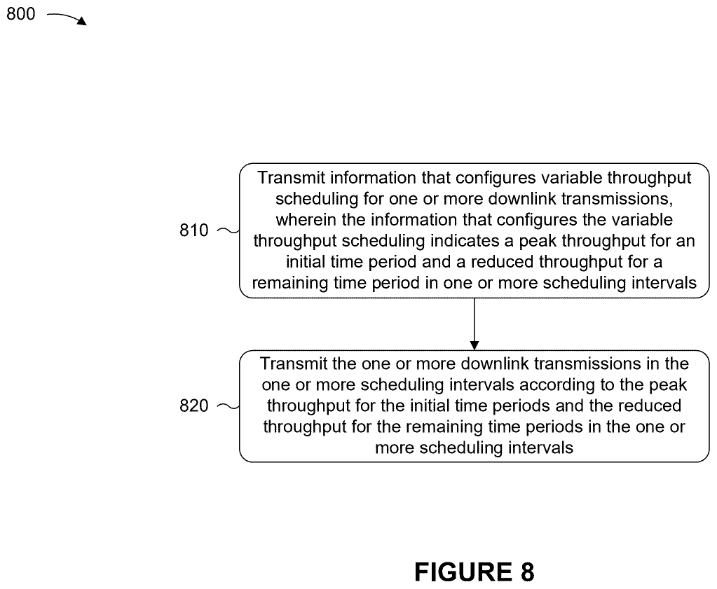

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with variable throughput wideband scheduling, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

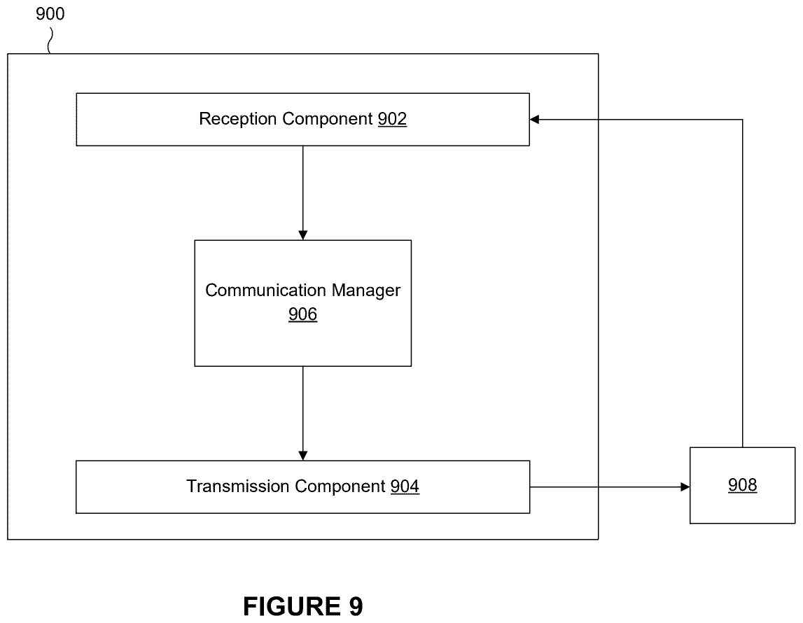

In some aspects, the UE 120 includes means for receiving information that configures variable throughput scheduling for one or more downlink transmissions, wherein the information that configures the variable throughput scheduling indicates a peak throughput for an initial time period and a reduced throughput for a remaining time period in one or more scheduling intervals; and/or means for receiving the one or more downlink transmissions in the one or more scheduling intervals according to the peak throughput for the initial time periods and the reduced throughput for the remaining time periods in the one or more scheduling intervals. The means for the UE 120 to perform operations described herein may include, for example, one or more of processing system 140, communication manager 150, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

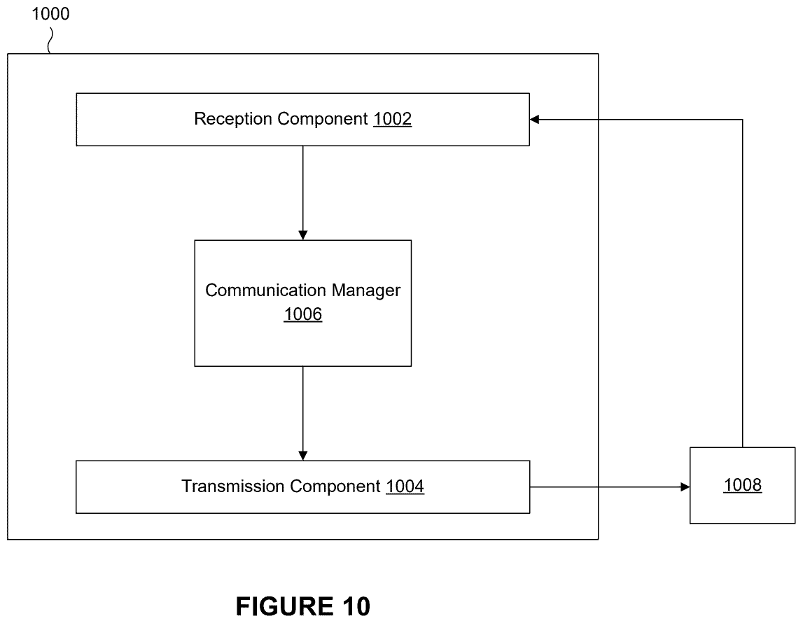

In some aspects, the network node 110 includes means for transmitting information that configures variable throughput scheduling for one or more downlink transmissions, wherein the information that configures the variable throughput scheduling indicates a peak throughput for an initial time period and a reduced throughput for a remaining time period in one or more scheduling intervals; and/or means for transmitting the one or more downlink transmissions in the one or more scheduling intervals according to the peak throughput for the initial time periods and the reduced throughput for the remaining time periods in the one or more scheduling intervals. The means for the network node 110 to perform operations described herein may include, for example, one or more of processing system 145, communication manager 155, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

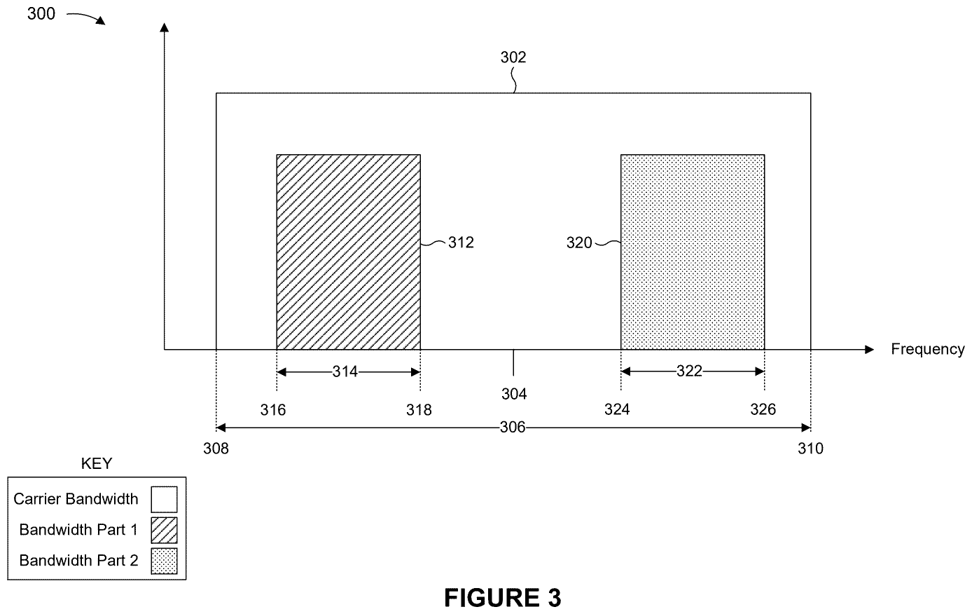

FIG. 3 is a diagram illustrating an example 300 of a BWP in accordance with the present disclosure. In some aspects, a wireless communication channel, also known as a carrier, may include a center frequency, a frequency bandwidth, and/or a set of RBs. For example, FIG. 3 illustrates a carrier 302 (shown in solid white) with a center frequency 304 (for example, a carrier frequency) and a frequency bandwidth 306. The frequency bandwidth 306 may be determined according to a first edge frequency 308 and a second edge frequency 310. Each RB associated with the carrier 302 may include a group of REs associated with a frequency partition (for example, a subcarrier spacing) and a time partition (for example, a slot or symbol duration). Accordingly, the set of RBs associated with the carrier 302 may collectively span a bandwidth (for example, the frequency bandwidth 306) and a corresponding time duration.

As described herein, a BWP may include a subset of contiguous RBs (and/or REs) within the set of RBs associated with a carrier, and a carrier may be partitioned into multiple BWPs (for example, four BWPs). The ability to partition the carrier into multiple BWPs may provide flexibility and efficient usage of the carrier bandwidth carrier. To illustrate, as shown in FIG. 3, the frequency bandwidth 306 may span 100 MHz and may be referred to as a wideband channel. Some UEs, such as an IoT device and/or a RedCap device, may lack capabilities that support wideband communications. For example, an IoT device may lack a transceiver with capabilities to transmit and/or receive a wideband signal. Additionally or alternatively, the IoT device may lack a processor with capabilities to process digital samples associated with the wideband signal in real-time. Accordingly, a network node may partition a carrier into one or more BWPs to communicate with the IoT device and/or other UE types. Additionally or alternatively, BWPs may be used to limit the maximum bandwidth that a UE uses to communicate, to reduce UE power consumption. To illustrate, the network node may select and/or configure a first BWP 312 within the carrier 302, where the first BWP 312 includes a frequency bandwidth 314 defined by a first frequency edge 316 and a second frequency edge 318. The network node may select and/or configure a second BWP 320 within the carrier 302, where the second BWP 320 includes a frequency bandwidth 322 defined by a first frequency edge 324 and a second frequency edge 326. The network node may select a default BWP (for example, defined by a communication standard) and/or may dynamically configure a BWP (for example, dynamically select a bandwidth and/or a frequency edge).

Although the example 300 in FIG. 3 shows the first BWP 312 and the second BWP 320 as having equal bandwidths and being positioned symmetrically within the carrier 302, other examples may include BWPs in a same carrier that have different properties (for example, different frequency bandwidths). For example, the first BWP 312 may be configured with a larger bandwidth relative to the second BWP 320 in accordance with the first BWP 312 being used for a higher data throughput relative to the second BWP 320. The second BWP 320 may be configured with a smaller bandwidth relative to the first BWP 312 to reduce a transmission size and/or reduce processing associated with the transmission, which may reduce power consumption at a UE. Thus, a network node may configure and/or select a BWP according to factors, such as UE power requirements, data throughput, and/or spectrum usage. For example, the network node may configure and/or select a BWP associated with a 5 MHz or smaller bandwidth to communicate with a RedCap UE, an IoT device, and/or another suitable device with limited capabilities or power requirements.

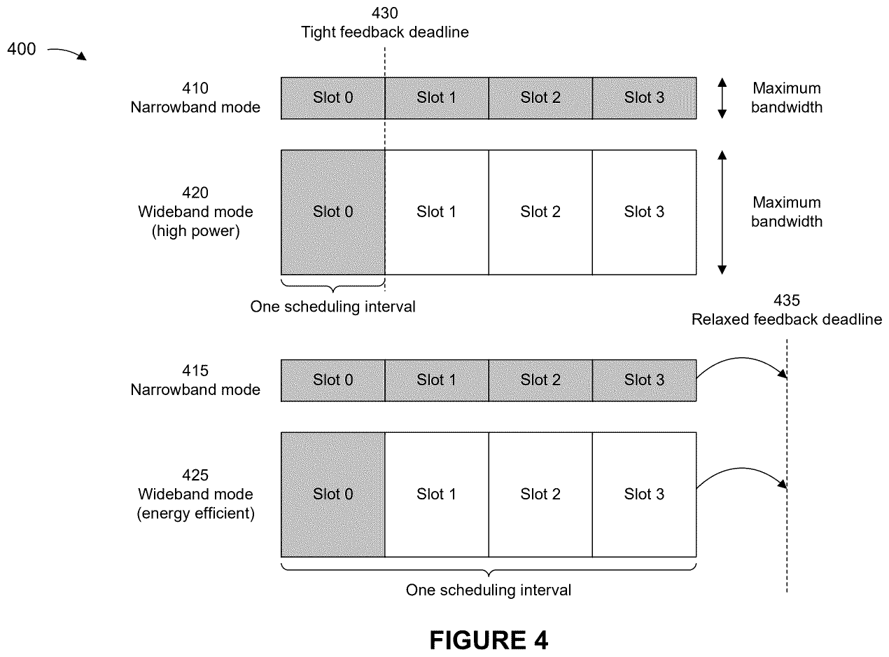

FIG. 4 is a diagram illustrating examples 400 of narrowband scheduling and wideband scheduling in accordance with the present disclosure. For example, FIG. 4 illustrates time and frequency resources for a UE 120 operating in a narrowband mode 410 and a wideband mode 420 associated with a tight (for example, default) feedback deadline 430 (for example, a deadline for providing ACK/NACK feedback that indicates whether the UE 120 successfully decoded or failed to decode a PDSCH transmission). As shown in FIG. 4, a maximum bandwidth available in the narrowband mode 410 is relatively small (for example, smaller than the maximum bandwidth available in the wideband mode 420). In the narrowband mode 410, the maximum available bandwidth limits the maximum throughput (for example, sustained throughput). Accordingly, in the narrowband mode 410, the UE 120 may process and provide feedback for a PDSCH transmission in a relatively short time window. For example, if the UE 120 is operating in the narrowband mode 410 and receives a PDSCH transmission in slot 0, the UE 120 may process and provide ACK/NACK feedback for the PDSCH transmission no later than the tight feedback deadline 430, before subsequent slot 1. Accordingly, the UE 120 may be ready to receive additional PDSCH transmissions in slot 1 or later slots.

In the wideband mode 420, the maximum available bandwidth is relatively large (for example, larger than the maximum available bandwidth in the narrowband mode 410). Therefore, the maximum throughput in the wideband mode 420 is greater than the maximum throughput in the narrowband mode 410. Accordingly, upon entering the wideband mode 420 with the tight feedback deadline 430, the UE 120 may need to enter a high-power state to process and provide feedback on a wideband PDSCH transmission in a relatively short time window. For example, if the UE 120 is operating in the wideband mode 420 and receives a wideband PDSCH transmission in slot 0, the UE 120 may need to enter the high-power state to process and provide feedback on the wideband PDSCH transmission before the tight feedback deadline 430 as in the narrowband mode 410. In the high-power state, the UE 120 may perform baseband processing at high power. For example, in the high-power state, the UE 120 may increase an internal baseband clock frequency and supply voltage, which can lead to an increase (for example, a quadratic increase) in power consumption and leakage.

As described herein, when the UE 120 is operating in the wideband mode 420 associated with the tight feedback deadline 430, the UE 120 may enter the high-power state to process and provide feedback on the wideband PDSCH transmissions by the tight feedback deadline 430 because a network node 110 could potentially schedule additional wideband PDSCH transmissions in slot 1, slot 2, slot 3, and/or later slots, and the UE 120 may be unable to process the additional wideband PDSCH transmissions if the UE 120 is still processing the wideband PDSCH transmission received in slot 0. Accordingly, entering the high-power state may help to ensure that the UE 120 can finish processing the wideband PDSCH transmission before slot 1, such that the UE can be ready to receive any additional wideband PDSCH transmissions after slot 0. However, in some cases, the network node 110 may not schedule any additional wideband PDSCH transmission after slot 0. In such cases, because the UE 120 does not need to process an additional wideband PDSCH transmission after slot 0, the UE 120 may not need to process and provide feedback on the wideband PDSCH transmission received in slot 0 by the tight feedback deadline 430. As a result, the UE 120 may not need to enter the high-power state to process and provide feedback on the wideband PDSCH transmission received in slot 0. Instead, in cases where the UE 120 is not scheduled with sustained peak throughput, the UE 120 may set a baseband clock frequency and a supply voltage at a level below the highest setting corresponding to wideband scheduling, which may conserve power at the UE 120.

Accordingly, to enable an energy-efficient narrowband scheduling mode 415 and/or an energy-efficient wideband scheduling mode 425, a network node 110 may configure a relaxed feedback deadline 435 and indicate how long the UE 120 will be scheduled in the wideband scheduling mode 425 (for example, that wideband PDSCH transmissions will be scheduled for a first quantity of slots) and/or that no additional wideband PDSCH transmissions will be scheduled (for example, for a second quantity of slots) after a wideband PDSCH transmission to provide a gap between the wideband PDSCH transmission and the relaxed feedback deadline 435. Accordingly, the network node 110 may indicate that the UE 120 will not be scheduled with sustained peak throughput, and the UE 120 may set the internal baseband clock and supply voltage at an appropriate level (for example, the UE 120 does not ramp up to the highest power level) according to how long the UE 120 will be scheduled in the wideband scheduling mode 425 and/or according to the length of the gap between the wideband PDSCH transmission and the relaxed feedback deadline 435. For example, when the energy-efficient wideband scheduling mode 425 is configured, the network node 110 may guarantee to the UE 120 that the maximum scheduled throughput will not exceed a limit, that the relaxed feedback timeline 435 is in effect, and that there will be gaps or reduced throughput periods between wideband PDSCH transmissions.

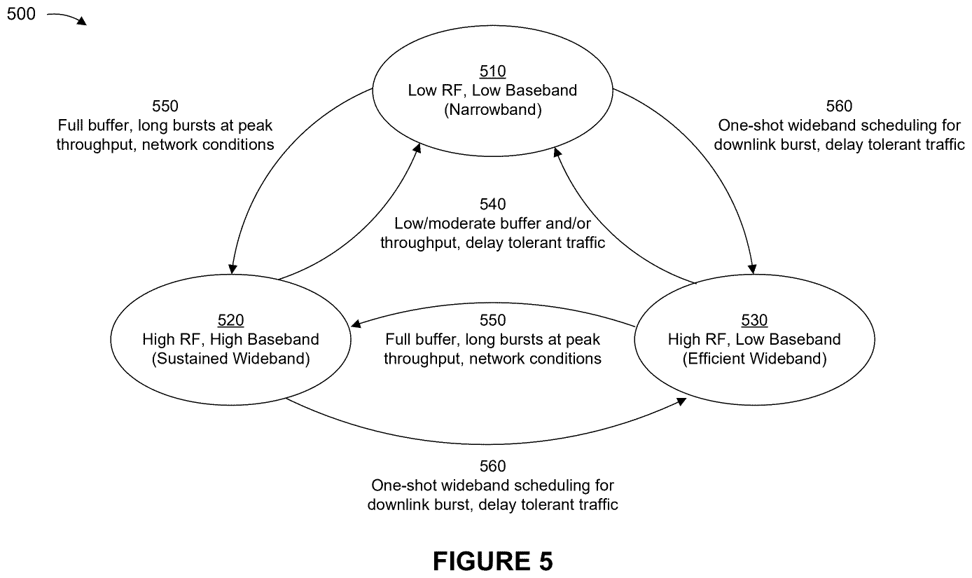

FIG. 5 is a diagram illustrating examples 500 of operating modes associated with a UE 120 in accordance with the present disclosure. More particularly, as shown in FIG. 5, a UE 120 may support a low-power operating mode 510 that may be used in a narrowband scheduling mode, a high-power operating mode 520 that may be used in a wideband scheduling mode associated with a sustained peak throughput, and an intermediate-power operating mode 530 that may be used in an energy-efficient wideband scheduling mode associated with a variable throughput.

As shown in FIG. 5, the low-power operating mode 510 may be used in a narrowband scheduling mode associated with a relatively low RF bandwidth and a low baseband clock frequency. As shown by reference number 540, the UE 120 may operate in or transition to the low-power operating mode 510 in scenarios where the UE 120 has relatively predictable and/or consistent traffic patterns with low or moderate buffered data volumes, low or moderate throughput demands, and/or delay-tolerant traffic. Accordingly, in narrowband or other scheduling modes that leverage a smaller RF bandwidth, such as a BWP or a portion of a carrier bandwidth, the UE 120 may set an internal baseband clock to a low frequency, and correspondingly set a supply voltage to a low level, to conserve power in the low-power operating mode 510.

As further shown in FIG. 5, the high-power operating mode 520 may be used in a sustained wideband scheduling mode associated with a relatively high RF bandwidth and a high baseband clock frequency. For example, the high-power operating mode 520 may be associated with state attributes such as a maximum (for example, wideband) RF bandwidth, a maximum quantity of activated component carriers, and/or a tight or default feedback deadline (for example, based on or otherwise associated with a small value for an N₁ parameter that represents a PDSCH processing time), among other examples. As shown by reference number 550, the UE 120 may operate in or transition to the high-power operating mode 520 in scenarios where a downlink buffer associated with the UE 120 is full or has substantial traffic to be delivered, where the UE 120 is scheduled with long downlink bursts at or near a peak (for example, wideband) throughput, and/or in accordance with network conditions (for example, available resources to allocate to the UE 120). Accordingly, in wideband scheduling modes that use a larger RF bandwidth to provide a high throughput that is sustained over time, the UE 120 may set a baseband clock to a high frequency and set a supply voltage to a high level to process sustained wideband PDSCH transmissions.

As further shown in FIG. 5, the intermediate-power operating mode 530 may be used in an energy-efficient wideband scheduling mode associated with a relatively high RF bandwidth and a low or moderate baseband clock frequency. For example, the intermediate-power operating mode 530 may be associated with state attributes such as a maximum (for example, wideband) RF bandwidth, one or more deactivated component carriers, and/or a relaxed feedback deadline (for example, based on or otherwise associated with a larger value for an N₁ parameter that represents a PDSCH processing time), among other examples. As shown by reference number 560, the UE 120 may operate in or transition to the intermediate-power operating mode 530 in scenarios such as one-shot wideband scheduling for a downlink traffic burst, delay-tolerant downlink traffic, and/or in accordance with network conditions (for example, limited resources to allocate to the UE 120). Accordingly, in wideband scheduling modes that use a larger RF bandwidth to provide a high throughput for a short time period, the UE 120 may set a baseband clock to a low or moderate frequency and set a supply voltage to a low or moderate level to process the wideband PDSCH transmissions and conserve power relative to the high-power operating mode 520. Furthermore, in the intermediate-power operating mode 530, the network node 110 may guarantee that the maximum scheduled throughput will not exceed a limit, that a relaxed feedback or N₁ timeline is in effect, and that there will be gaps or reduced throughput periods between wideband PDSCH transmissions.

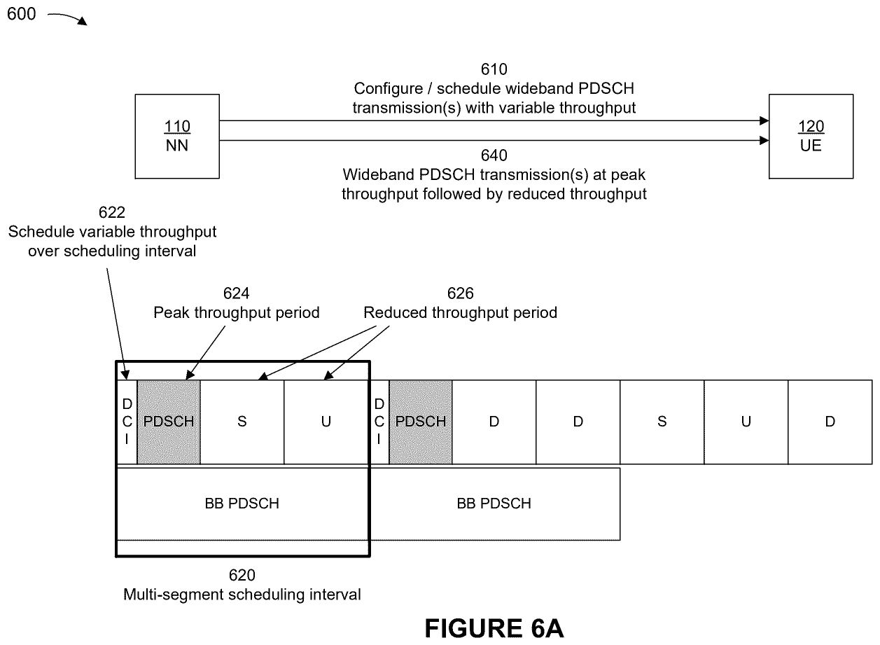

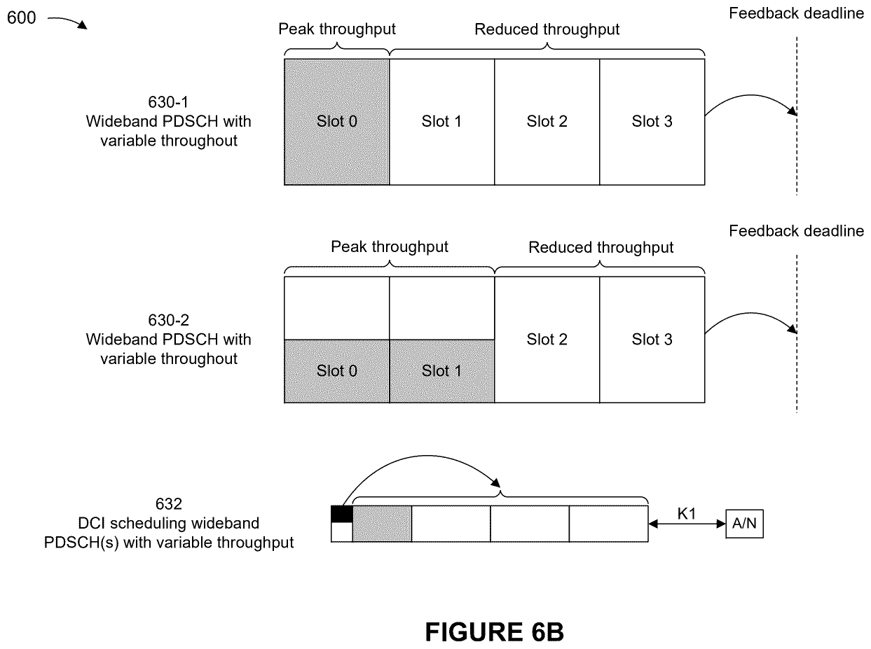

FIGS. 6A-6B are diagrams illustrating examples 600 associated with variable throughput wideband scheduling in accordance with the present disclosure. As shown in FIG. 6A, examples 600 include communication between a network node 110 and a UE 120. In some aspects, the network node 110 and the UE 120 may communicate in a wireless network, such as wireless communication network 100, via a wireless access link, which may include an uplink and a downlink.

As shown in FIG. 6A, in a first operation 610, the network node 110 may transmit, and the UE 120 may receive, information that configures and/or schedules one or more wideband PDSCH transmissions with a variable throughput. For example, as described herein, the one or more wideband PDSCH transmissions may each be configured and/or scheduled for transmission over a scheduling interval that includes multiple segments, where each segment corresponds to a transmission time interval (TTIs) (for example, a slot, mini-slot, and/or a symbol, among other examples). Furthermore, in some aspects, the variable throughput for the one or more wideband PDSCH transmissions may be configured and/or scheduled such that each scheduling interval includes an initial time period that spans one or more segments (for example, one or more slots) associated with a peak throughput and a remaining time period that spans one or more segments (for example, one or more slots) associated with a reduced throughput. For example, in some aspects, the peak throughput may be a maximum sustained throughput over the scheduling interval, which may be associated with a wideband RB allocation or another suitable non-zero RB allocation (for example, exceeding a narrowband allocation), and the reduced throughput is lower than the peak throughput (for example, a zero RB allocation or another suitable RB allocation, such as a narrowband allocation).

Accordingly, when the network node 110 configures wideband scheduling with a variable throughput, the UE 120 may generally expect each wideband PDSCH transmission scheduled by the network node 110 to be associated with a peak throughput over an initial time period and a reduced throughput over a remaining time period. Furthermore, when wideband scheduling with a variable throughput is configured, each wideband PDSCH transmission may be associated with a relaxed feedback timeline, which may be measured from the end of the wideband PDSCH transmission (for example, from the last symbol of the wideband PDSCH transmission, which corresponds to the last symbol of the remaining time period associated with the reduced throughput). Accordingly, the UE 120 may process the wideband PDSCH transmission over the entire scheduling interval, including the initial time period associated with the peak throughput and the remaining time period associated with the reduced throughput, and the UE 120 may provide feedback to the network node 110 to indicate whether the wideband PDSCH transmission was successfully decoded according to the relaxed feedback timeline. In this way, the UE 120 may set an internal baseband clock to a suitable frequency, and may set a supply voltage at a suitable level, to ensure that the UE 120 will finish processing the wideband PDSCH transmission before the relaxed feedback timeline. Furthermore, the frequency associated with the internal baseband clock and the supply voltage level may be below a baseband clock frequency and supply voltage level associated with a maximum wideband throughput, respectively, whereby the wideband scheduling with variable throughput conserves power at the UE 120 relative to wideband scheduling at the maximum throughput.

In some aspects, FIG. 6A illustrates an example timeline associated with wideband scheduling with a variable throughput. For example, as shown in FIG. 6A, a wideband PDSCH transmission may be scheduled over a multi-segment scheduling interval 620, which includes three slots in the illustrated example. As further shown, the network node 110 may transmit, and the UE 120 may receive, a DCI message 622 that schedules the wideband PDSCH transmission with the variable throughput. For example, as shown, the multi-segment scheduling interval 620 includes an initial time period 624 (for example, one slot) in which the wideband PDSCH transmission is transmitted at a peak throughput, and a remaining time period 626 (for example, two slots) associated with a reduced throughput (for example, a zero RB allocation or another FDRA below the peak throughput used during the initial time period 624). In this way, the UE 120 expects no PDSCH scheduling or PDSCH scheduling at a reduced throughput during the remaining time period 626 that follows the initial time period 624 associated with the peak throughput for the wideband PDSCH transmission. Furthermore, as described herein, the DCI message 622 may configure the peak throughput for the initial time period 624 and the reduced throughput for the remaining time period 626 (for example, by signaling the segment(s) associated with the peak throughput and the segment(s) associated with the reduced throughput). For example, in some aspects, the DCI message 622 may include one or more parameters associated with a PDSCH repetition or TBOMS signaling framework, a fluid SLIV and/or separate FDRA fields for different segments, a TDRA table with one or more rows that support wideband PDSCH scheduling with a variable throughput, and/or a TDRA table with a skipping indication, among other examples.

For example, in some aspects, the DCI message 622 may include a TDRA field that indicates an index associated with a row in a TDRA table, where each row may indicate a DMRS position, a PDSCH mapping type (for example, type A corresponding to slot-based scheduling or type B corresponding to mini-slot-based scheduling), a K₀ value corresponding an offset from the DCI message 622 to an initial slot carrying a PDSCH transmission, a starting symbol for PDSCH transmission within the initial slot carrying the PDSCH transmission, and a length value corresponding to a quantity of consecutive symbols associated with the PDSCH transmission. Furthermore, in some aspects, one or more rows in the TDRA table may include one or more parameters related to PDSCH repetition or TBOMS transmission. For example, in some aspects, the rows in the TDRA table that support PDSCH repetition or TBOMS transmission may indicate a quantity of repetitions and a quantity of slots for a scheduled PDSCH transmission. Accordingly, to schedule a wideband PDSCH transmission with a variable throughput, the TDRA field in the DCI message 622 may indicate a row in the TDRA table associated with one repetition and more than one slot.

Furthermore, to indicate the variable throughput associated with the wideband PDSCH transmission, the DCI message 622 may include one or more parameters to indicate different FDRAs and/or different SLIVs for the multiple segments associated with the wideband PDSCH transmission. For example, in some aspects, the DCI message 622 may include a first FDRA field to indicate the peak throughput associated with the initial time period 624 (for example, according to a first starting RB and a first quantity of consecutive RBs) and a second FDRA field to indicate the reduced throughput associated with the remaining time period 626 (for example, according to a second starting RB and a second quantity of consecutive RBs). Additionally or alternatively, in cases where the reduced throughput for the remaining time period 626 is a zero RB allocation (for example, a scheduling gap), the second FDRA field may indicate the zero RB allocation by setting every bit in the second FDRA field to zero or by setting every bit in the second FDRA field to one. In some other examples, the DCI message 622 may include one or more slot offset indicators to indicate one or more slots that correspond to the initial time period 624 and/or the remaining time period 626 within the multi-segment scheduling interval 620. Additionally, or alternatively, in some aspects, the DCI message 622 may include a first SLIV field to indicate a starting symbol and a quantity of consecutive symbols associated with the initial time period 624 and a second SLIV field to indicate a starting symbol and a quantity of consecutive symbols associated with the remaining time period 626. For example, in cases where the reduced throughput for the remaining time period 626 is a zero RB allocation (for example, a scheduling gap), the second SLIV field may have a zero value.

For example, FIG. 6B illustrates a first example 630-1 associated with a wideband PDSCH transmission scheduled with a variable throughput. For example, in the first example 630-1, the scheduling DCI may indicate that the wideband PDSCH transmission spans four slots, where the initial time period spans a first slot (slot 0) and an FDRA for the initial time period is associated with a non-zero RB allocation corresponding to a peak (for example, wideband) throughput. As further shown, the remaining time period spans three slots (slots 1-3) and an FDRA for the remaining time period is associated with a reduced (for example, zero RB) throughput. In some aspects, the scheduling DCI may further include multiple SLIVs, slot offset indicators, or other suitable parameters to indicate the slot(s) associated with the initial time period and/or the slot(s) associated with the remaining time period.

Similarly, FIG. 6B illustrates a second example 630-2 associated with a wideband PDSCH transmission scheduled with a variable throughput. In the second example 630-2, the scheduling DCI may indicate that the wideband PDSCH transmission spans four slots, where the initial time period spans two slots (slots 0-1) and an FDRA for the initial time period is associated with a non-zero RB allocation corresponding to a peak throughput. In the second example 630-2, the peak throughput may be associated with a wideband allocation (for example, larger than a narrowband allocation) that is below a maximum available wideband allocation. As further shown, the remaining time period spans two slots (slots 2-3) and an FDRA for the remaining time period is associated with a reduced (for example, zero RB) throughput. In some aspects, the scheduling DCI may further include multiple SLIVs, slot offset indicators, or other suitable parameters to indicate the slot(s) associated with the initial time period and/or the slot(s) associated with the remaining time period.

In some aspects, the network node 110 may provide the information configuring and/or scheduling the wideband PDSCH transmission with the variable throughput in connection with a BWP switch indication (for example, an indication to switch from a narrowband BWP to a wideband BWP). For example, FIG. 6B illustrates an example 632 where a single DCI schedules multiple PDSCH transmissions that are each associated with a separate FDRA field. For example, the DCI that schedules the multiple PDSCH transmissions may insert gaps between successive PDSCH transmissions, such that the DCI indicates a peak throughput (or non-zero RB allocation) for one or more segments and a reduced throughput (or zero RB allocation) for one or more segments over a quantity of consecutive segments. In this way, the DCI may dynamically indicate the quantity of segments associated with the peak throughput and the quantity of segments associated with the reduced throughput, with the segments associated with the reduced throughput providing gaps between the segments associated with the peak throughput (for example, depending on a buffer size associated with the UE 120 and/or a maximum sustained throughput for the UE 120). Furthermore, in cases where a K₀ parameter (for example, indicating an offset from the scheduling DCI to the first segment of the wideband PDSCH transmission) exceeds Kₘᵢₙ (for example, an amount of time sufficient to tune or otherwise change the baseband clock frequency), the DCI may schedule the variable throughput wideband PDSCH transmission within a current BWP (for example, independent from a BWP switch indication).

Additionally, or alternatively, the DCI scheduling the variable throughput wideband PDSCH transmission may include a TDRA field that indicates an index associated with a row in the TDRA table for PDSCH transmissions that are in consecutive slots. For example, the TDRA table may include one or more rows for PDSCH and/or PUSCH (generally denoted PxSCH) transmissions in consecutive slots, and each such row may configure a SLIV, a mapping type, a scheduling offset (for example, a K₀ parameter for a PDSCH or a K₂ parameter for a PUSCH) for each PxSCH transmission in the row. Accordingly, when the TDRA field in the scheduling DCI indicates an index associated with a row in the TDRA table for a wideband PDSCH transmission, a SLIV following the wideband PDSCH transmission may have a zero value to indicate the remaining time period associated with the reduced throughput. Additionally, or alternatively, the TDRA table may include a skipping indication, such as a quantity of slots after the SLIV that will not contain PDSCH data or PDSCH segments or a skipping duration explicitly indicated according to an amount of time (for example, a quantity of milliseconds) or a quantity of remaining segments after the SLIV that corresponds to the initial time period (for example, a quantity of remaining segments from the end of the initial time period to the end of the scheduling interval).

Accordingly, as shown in FIG. 6A, in a second operation 640, the network node 110 may transmit, and the UE 120 may receive, the one or more wideband PDSCH transmissions over the one or more scheduling intervals in accordance with the peak throughput for the initial time periods and the reduced throughput for the remaining time periods in each of the one or more scheduling intervals. Furthermore, as described herein and shown by example 632 of FIG. 6B, a timeline for providing feedback associated with the wideband PDSCH transmissions may be measured from the last symbol of the scheduling interval (for example, a K₁ parameter may indicate an offset from the last symbol of the scheduling interval to a PUCCH occasion to carry ACK/NACK feedback for the wideband PDSCH transmission). Accordingly, as described herein, the UE 120 may set an internal baseband clock to an appropriate frequency, and may set a supply voltage to an appropriate level, to ensure that the UE 120 will finish processing downlink data received during the initial time period (and during the remaining time period, if the reduced throughput is associated with a non-zero RB allocation) before the relaxed feedback deadline. For example, because the wideband PDSCH transmission is transmitted at a reduced (possibly zero) throughput during the remaining time period, the UE 120 can set the internal baseband clock to a frequency and the supply voltage to a level below what may otherwise be needed in the case of a wideband PDSCH transmission with a sustained peak throughput and a tight feedback deadline. In this way, the UE 120 may conserve power relative to the operational state associated with wideband PDSCH transmissions with sustained peak throughputs and/or and tight feedback deadlines.

FIG. 7 is a flowchart illustrating an example process 700 performed, for example, at a UE or an apparatus of a UE that supports wireless communication in accordance with the present disclosure. Example process 700 is an example where the apparatus or the UE (for example, UE 120) performs operations associated with variable throughput wideband scheduling.

As shown in FIG. 7, in some aspects, process 700 may include receiving information that configures variable throughput scheduling for one or more downlink transmissions, wherein the information that configures the variable throughput scheduling indicates a peak throughput for an initial time period and a reduced throughput for a remaining time period in one or more scheduling intervals (block 710). For example, the UE (such as by using communication manager 906 or reception component 902, depicted in FIG. 9) may receive information that configures variable throughput scheduling for one or more downlink transmissions, wherein the information that configures the variable throughput scheduling indicates a peak throughput for an initial time period and a reduced throughput for a remaining time period in one or more scheduling intervals, as described above.

As further shown in FIG. 7, in some aspects, process 700 may include receiving the one or more downlink transmissions in the one or more scheduling intervals according to the peak throughput for the initial time periods and the reduced throughput for the remaining time periods in the one or more scheduling intervals (block 720). For example, the UE (such as by using communication manager 906 or reception component 902, depicted in FIG. 9) may receive the one or more downlink transmissions in the one or more scheduling intervals according to the peak throughput for the initial time periods and the reduced throughput for the remaining time periods in the one or more scheduling intervals, as described above.

Process 700 may include additional aspects, such as any single aspect or any combination of aspects described below or in connection with one or more other processes described elsewhere herein.

In a first additional aspect, the information configuring the variable throughput scheduling comprises a DCI message indicating one repetition and multiple slots for each of the one or more downlink transmissions.

In a second additional aspect, alone or in combination with the first aspect, the information configuring the variable throughput scheduling indicates the peak throughput according to a first FDRA and indicates the reduced throughput according to a second FDRA.

In a third additional aspect, alone or in combination with one or more of the first and second aspects, the first FDRA is a non-zero RB allocation and the second FDRA is a zero RB allocation.

In a fourth additional aspect, alone or in combination with one or more of the first through third aspects, the zero RB allocation is indicated in an FDRA field in which every bit is set to zero or every bit is set to one.

In a fifth additional aspect, alone or in combination with one or more of the first through fourth aspects, the information that configures the variable throughput scheduling includes a slot offset indicator that indicates one or more slots associated with the non-zero RB allocation.

In a sixth additional aspect, alone or in combination with one or more of the first through fifth aspects, the information configuring the variable throughput scheduling indicates the initial time period according to a first SLIV and indicates the remaining time period according to a second SLIV.

In a seventh additional aspect, alone or in combination with one or more of the first through sixth aspects, a value of the second SLIV is zero.

In an eighth additional aspect, alone or in combination with one or more of the first through seventh aspects, the information configures the variable throughput scheduling in association with an indication to switch a BWP.

In a ninth additional aspect, alone or in combination with one or more of the first through eighth aspects, the information configures the variable throughput scheduling within a BWP according to an offset, to the initial time period associated with the peak throughput, that satisfies a threshold related to tuning one or more of a baseband clock or a baseband voltage according to the peak throughput.

In a tenth additional aspect, alone or in combination with one or more of the first through ninth aspects, the information that configures the variable throughput scheduling indicates the remaining time period associated with the reduced throughput according to a TDRA associated with a skipping indication.

In an eleventh additional aspect, alone or in combination with one or more of the first through tenth aspects, the TDRA is associated with a SLIV and the skipping indication is indicated according to a quantity of slots after the SLIV that are associated with the reduced throughput.

In a twelfth additional aspect, alone or in combination with one or more of the first through eleventh aspects, the skipping indication is indicated according to a duration of time or a quantity of slots that remain in each of the one or more scheduling intervals after a SLIV associated with the TDRA.

In a thirteenth additional aspect, alone or in combination with one or more of the first through twelfth aspects, process 700 includes transmitting feedback associated with the one or more downlink transmissions according to an offset from a last symbol of a last downlink transmission of the one or more downlink transmissions.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node that supports wireless communication in accordance with the present disclosure. Example process 800 is an example where the apparatus or the network node (for example, network node 110) performs operations associated with variable throughput wideband scheduling.

As shown in FIG. 8, in some aspects, process 800 may include transmitting information that configures variable throughput scheduling for one or more downlink transmissions, wherein the information that configures the variable throughput scheduling indicates a peak throughput for an initial time period and a reduced throughput for a remaining time period in one or more scheduling intervals (block 810). For example, the network node (such as by using communication manager 1006 or transmission component 1004, depicted in FIG. 10) may transmit information that configures variable throughput scheduling for one or more downlink transmissions, wherein the information that configures the variable throughput scheduling indicates a peak throughput for an initial time period and a reduced throughput for a remaining time period in one or more scheduling intervals, as described above.

As further shown in FIG. 8, in some aspects, process 800 may include transmitting the one or more downlink transmissions in the one or more scheduling intervals according to the peak throughput for the initial time periods and the reduced throughput for the remaining time periods in the one or more scheduling intervals (block 820). For example, the network node (such as by using communication manager 1006 or transmission component 1004, depicted in FIG. 10) may transmit the one or more downlink transmissions in the one or more scheduling intervals according to the peak throughput for the initial time periods and the reduced throughput for the remaining time periods in the one or more scheduling intervals, as described above.

Process 800 may include additional aspects, such as any single aspect or any combination of aspects described below or in connection with one or more other processes described elsewhere herein.

In a first additional aspect, the information configuring the variable throughput scheduling comprises a DCI message indicating one repetition and multiple slots for each of the one or more downlink transmissions.

In a second additional aspect, alone or in combination with the first aspect, the information configuring the variable throughput scheduling indicates the peak throughput according to a first FDRA and indicates the reduced throughput according to a second FDRA.

In a third additional aspect, alone or in combination with one or more of the first and second aspects, the first FDRA is a non-zero RB allocation and the second FDRA is a zero RB allocation.

In a fourth additional aspect, alone or in combination with one or more of the first through third aspects, the zero RB allocation is indicated in an FDRA field in which every bit is set to zero or every bit is set to one.

In a fifth additional aspect, alone or in combination with one or more of the first through fourth aspects, the information that configures the variable throughput scheduling includes a slot offset indicator that indicates one or more slots associated with the non-zero RB allocation.

In a sixth additional aspect, alone or in combination with one or more of the first through fifth aspects, the information configuring the variable throughput scheduling indicates the initial time period according to a first SLIV and indicates the remaining time period according to a second SLIV.

In a seventh additional aspect, alone or in combination with one or more of the first through sixth aspects, a value of the second SLIV is zero.

In an eighth additional aspect, alone or in combination with one or more of the first through seventh aspects, the information configures the variable throughput scheduling in association with an indication to switch a BWP.

In a ninth additional aspect, alone or in combination with one or more of the first through eighth aspects, the information configures the variable throughput scheduling within a BWP according to an offset, to the initial time period associated with the peak throughput, that satisfies a threshold related to tuning one or more of a baseband clock or a baseband voltage according to the peak throughput.

In a tenth additional aspect, alone or in combination with one or more of the first through ninth aspects, the information that configures the variable throughput scheduling indicates the remaining time period associated with the reduced throughput according to a TDRA associated with a skipping indication.

In an eleventh additional aspect, alone or in combination with one or more of the first through tenth aspects, the TDRA is associated with a SLIV and the skipping indication is indicated according to a quantity of slots after the SLIV that are associated with the reduced throughput.

In a twelfth additional aspect, alone or in combination with one or more of the first through eleventh aspects, the skipping indication is indicated according to a duration of time or a quantity of slots that remain in each of the one or more scheduling intervals after a SLIV associated with the TDRA.

In a thirteenth additional aspect, alone or in combination with one or more of the first through twelfth aspects, process 800 includes receiving feedback associated with the one or more downlink transmissions according to an offset from a last symbol of a last downlink transmission of the one or more downlink transmissions.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports wireless communication in accordance with the present disclosure. The apparatus 900 may be a UE, or a UE may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 140). In some aspects, the communication manager 906 is the communication manager 150

In some aspects, the apparatus 900 may be configured to and/or operable to perform one or more operations described herein in connection with FIGS. 6A-6B. Additionally or alternatively, the apparatus 900 may be configured to and/or operable to perform one or more processes described herein, such as process 700 of FIG. 7.

The reception component 902 may receive communications, such as reference signals, control information, and/or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the UE 120 described above in connection with FIG. 1, such as a radio, one or more RF chains, one or more transceivers, or one or more modems, each of which may in turn be coupled with one or more antennas of the UE 120.

The transmission component 904 may transmit communications, such as reference signals, control information, and/or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the UE 120 described above in connection with FIG. 1, such as a radio, one or more RF chains, one or more transceivers, or one or more modems, each of which may in turn be coupled with one or more antennas of the UE 120. In some aspects, the transmission component 904 may be co-located with the reception component 902.

The communication manager 906 may receive or may cause the reception component 902 to receive information that configures variable throughput scheduling for one or more downlink transmissions, wherein the information that configures the variable throughput scheduling indicates a peak throughput for an initial time period and a reduced throughput for a remaining time period in one or more scheduling intervals. The communication manager 906 may receive or may cause the reception component 902 to receive the one or more downlink transmissions in the one or more scheduling intervals according to the peak throughput for the initial time periods and the reduced throughput for the remaining time periods in the one or more scheduling intervals. In some aspects, the communication manager 06 may perform one or more operations described elsewhere herein as being performed by one or more components of the communication manager 06.

In some aspects, the communication manager 906 includes a set of components. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 902 may receive information that configures variable throughput scheduling for one or more downlink transmissions, wherein the information that configures the variable throughput scheduling indicates a peak throughput for an initial time period and a reduced throughput for a remaining time period in one or more scheduling intervals. The reception component 902 may receive the one or more downlink transmissions in the one or more scheduling intervals according to the peak throughput for the initial time periods and the reduced throughput for the remaining time periods in the one or more scheduling intervals.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports wireless communication in accordance with the present disclosure. The apparatus 1000 may be a network node, or a network node may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 145). In some aspects, the communication manager 1006 is the communication manager 155

In some aspects, the apparatus 1000 may be configured to and/or operable to perform one or more operations described herein in connection with FIGS. 6A-6B. Additionally or alternatively, the apparatus 1000 may be configured to and/or operable to perform one or more processes described herein, such as process 800 of FIG. 8.

The reception component 1002 may receive communications, such as reference signals, control information, and/or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the network node 110 described above in connection with FIG. 1, such as a radio, one or more RF chains, one or more transceivers, or one or more modems, each of which may in turn be coupled with one or more antennas of the network node 110.

The transmission component 1004 may transmit communications, such as reference signals, control information, and/or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the network node 110 described above in connection with FIG. 1, such as a radio, one or more RF chains, one or more transceivers, or one or more modems, each of which may in turn be coupled with one or more antennas of the network node 110. In some aspects, the transmission component 1004 may be co-located with the reception component 1002.

The communication manager 1006 may transmit or may cause the transmission component 1004 to transmit information that configures variable throughput scheduling for one or more downlink transmissions, wherein the information that configures the variable throughput scheduling indicates a peak throughput for an initial time period and a reduced throughput for a remaining time period in one or more scheduling intervals. The communication manager 1006 may transmit or may cause the transmission component 1004 to transmit the one or more downlink transmissions in the one or more scheduling intervals according to the peak throughput for the initial time periods and the reduced throughput for the remaining time periods in the one or more scheduling intervals. In some aspects, the communication manager 06 may perform one or more operations described elsewhere herein as being performed by one or more components of the communication manager 06.

In some aspects, the communication manager 1006 includes a set of components. Alternatively, the set of components may be separate and distinct from the communication manager 1006. As used herein, the term “component” is intended to be broadly construed as hardware or a combination of hardware and at least one of software or firmware. In some aspects, one or more components of the set of components may include or may be implemented within a processing system (for example, the processing system 150). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1004 may transmit information that configures variable throughput scheduling for one or more downlink transmissions, wherein the information that configures the variable throughput scheduling indicates a peak throughput for an initial time period and a reduced throughput for a remaining time period in one or more scheduling intervals. The transmission component 1004 may transmit the one or more downlink transmissions in the one or more scheduling intervals according to the peak throughput for the initial time periods and the reduced throughput for the remaining time periods in the one or more scheduling intervals.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a UE, comprising: receiving information that configures variable throughput scheduling for one or more downlink transmissions, wherein the information that configures the variable throughput scheduling indicates a peak throughput for an initial time period and a reduced throughput for a remaining time period in one or more scheduling intervals; and receiving the one or more downlink transmissions in the one or more scheduling intervals according to the peak throughput for the initial time periods and the reduced throughput for the remaining time periods in the one or more scheduling intervals.
Aspect 2: The method of Aspect 1, wherein the information configuring the variable throughput scheduling comprises a DCI message indicating one repetition and multiple slots for each of the one or more downlink transmissions.
Aspect 3: The method of any of Aspects 1-2, wherein the information configuring the variable throughput scheduling indicates the peak throughput according to a first FDRA and indicates the reduced throughput according to a second FDRA.
Aspect 4: The method of Aspect 3, wherein the first FDRA is a non-zero RB allocation and the second FDRA is a zero RB allocation.
Aspect 5: The method of Aspect 4, wherein the zero RB allocation is indicated in an FDRA field in which every bit is set to zero or every bit is set to one.
Aspect 6: The method of Aspect 4, wherein the information that configures the variable throughput scheduling includes a slot offset indicator that indicates one or more slots associated with the non-zero RB allocation.
Aspect 7: The method of any of Aspects 1-6, wherein the information configuring the variable throughput scheduling indicates the initial time period according to a first SLIV and indicates the remaining time period according to a second SLIV.
Aspect 8: The method of Aspect 7, wherein a value of the second SLIV is zero.
Aspect 9: The method of any of Aspects 1-8, wherein the information configures the variable throughput scheduling in association with an indication to switch a BWP.
Aspect 10: The method of any of Aspects 1-9, wherein the information configures the variable throughput scheduling within a BWP according to an offset, to the initial time period associated with the peak throughput, that satisfies a threshold related to tuning one or more of a baseband clock or a baseband voltage according to the peak throughput.
Aspect 11: The method of any of Aspects 1-10, wherein the information that configures the variable throughput scheduling indicates the remaining time period associated with the reduced throughput according to a TDRA associated with a skipping indication.
Aspect 12: The method of Aspect 11, wherein the TDRA is associated with a SLIV and the skipping indication is indicated according to a quantity of slots after the SLIV that are associated with the reduced throughput.
Aspect 13: The method of Aspect 11, wherein the skipping indication is indicated according to a duration of time or a quantity of slots that remain in each of the one or more scheduling intervals after a SLIV associated with the TDRA.
Aspect 14: The method of any of Aspects 1-13, further comprising: transmitting feedback associated with the one or more downlink transmissions according to an offset from a last symbol of a last downlink transmission of the one or more downlink transmissions.
Aspect 15: A method of wireless communication performed by a network node, comprising: transmitting information that configures variable throughput scheduling for one or more downlink transmissions, wherein the information that configures the variable throughput scheduling indicates a peak throughput for an initial time period and a reduced throughput for a remaining time period in one or more scheduling intervals; and transmitting the one or more downlink transmissions in the one or more scheduling intervals according to the peak throughput for the initial time periods and the reduced throughput for the remaining time periods in the one or more scheduling intervals.
Aspect 16: The method of Aspect 15, wherein the information configuring the variable throughput scheduling comprises a DCI message indicating one repetition and multiple slots for each of the one or more downlink transmissions.
Aspect 17: The method of any of Aspects 15-16, wherein the information configuring the variable throughput scheduling indicates the peak throughput according to a first FDRA and indicates the reduced throughput according to a second FDRA.
Aspect 18: The method of Aspect 17, wherein the first FDRA is a non-zero RB allocation and the second FDRA is a zero RB allocation.
Aspect 19: The method of Aspect 18, wherein the zero RB allocation is indicated in an FDRA field in which every bit is set to zero or every bit is set to one.
Aspect 20: The method of Aspect 18, wherein the information that configures the variable throughput scheduling includes a slot offset indicator that indicates one or more slots associated with the non-zero RB allocation.
Aspect 21: The method of any of Aspects 15-20, wherein the information configuring the variable throughput scheduling indicates the initial time period according to a first SLIV and indicates the remaining time period according to a second SLIV.
Aspect 22: The method of Aspect 21, wherein a value of the second SLIV is zero.
Aspect 23: The method of any of Aspects 15-22, wherein the information configures the variable throughput scheduling in association with an indication to switch a BWP.
Aspect 24: The method of any of Aspects 15-23, wherein the information configures the variable throughput scheduling within a BWP according to an offset, to the initial time period associated with the peak throughput, that satisfies a threshold related to tuning one or more of a baseband clock or a baseband voltage according to the peak throughput.
Aspect 25: The method of any of Aspects 15-24, wherein the information that configures the variable throughput scheduling indicates the remaining time period associated with the reduced throughput according to a TDRA associated with a skipping indication.
Aspect 26: The method of Aspect 25, wherein the TDRA is associated with a SLIV and the skipping indication is indicated according to a quantity of slots after the SLIV that are associated with the reduced throughput.
Aspect 27: The method of Aspect 25, wherein the skipping indication is indicated according to a duration of time or a quantity of slots that remain in each of the one or more scheduling intervals after a SLIV associated with the TDRA.
Aspect 28: The method of any of Aspects 15-27, further comprising: receiving feedback associated with the one or more downlink transmissions according to an offset from a last symbol of a last downlink transmission of the one or more downlink transmissions.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more. ” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive information that configures variable throughput scheduling for one or more downlink transmissions, wherein the information that configures the variable throughput scheduling indicates a peak throughput for an initial time period and a reduced throughput for a remaining time period in one or more scheduling intervals; and
receive the one or more downlink transmissions in the one or more scheduling intervals according to the peak throughput for the initial time periods and the reduced throughput for the remaining time periods in the one or more scheduling intervals.

2. The UE of claim 1, wherein the information configuring the variable throughput scheduling comprises a downlink control information (DCI) message indicating one repetition and multiple slots for each of the one or more downlink transmissions.

3. The UE of claim 1, wherein the information configuring the variable throughput scheduling indicates the peak throughput according to a first frequency domain resource assignment (FDRA) and indicates the reduced throughput according to a second FDRA.

4. The UE of claim 3, wherein the first FDRA is a non-zero resource block (RB) allocation and the second FDRA is a zero RB allocation.

5. The UE of claim 4, wherein the zero RB allocation is indicated in an FDRA field in which every bit is set to zero or every bit is set to one.

6. The UE of claim 4, wherein the information that configures the variable throughput scheduling includes a slot offset indicator that indicates one or more slots associated with the non-zero RB allocation.

7. The UE of claim 1, wherein the information configuring the variable throughput scheduling indicates the initial time period according to a first start and length indicator value (SLIV) and indicates the remaining time period according to a second SLIV.

8. The UE of claim 7, wherein a value of the second SLIV is zero.

9. The UE of claim 1, wherein the information configures the variable throughput scheduling in association with an indication to switch a bandwidth part.

10. The UE of claim 1, wherein the information configures the variable throughput scheduling within a bandwidth part according to an offset, to the initial time period associated with the peak throughput, that satisfies a threshold related to tuning one or more of a baseband clock or a baseband voltage according to the peak throughput.

11. The UE of claim 1, wherein the information that configures the variable throughput scheduling indicates the remaining time period associated with the reduced throughput according to a time domain resource assignment (TDRA) associated with a skipping indication.

12. The UE of claim 11, wherein the TDRA is associated with a start and length indicator value (SLIV) and the skipping indication is indicated according to a quantity of slots after the SLIV that are associated with the reduced throughput.

13. The UE of claim 11, wherein the skipping indication is indicated according to a duration of time or a quantity of slots that remain in each of the one or more scheduling intervals after a start and length indicator value (SLIV) associated with the TDRA.

14. The UE of claim 1, wherein the processing system is further configured to cause the UE to:
transmit feedback associated with the one or more downlink transmissions according to an offset from a last symbol of a last downlink transmission of the one or more downlink transmissions.

15. A network node for wireless communication, comprising:
a processing system that includes one or more processors and one or more memories coupled with the one or more processors, the processing system configured to cause the network node to:
transmit information that configures variable throughput scheduling for one or more downlink transmissions, wherein the information that configures the variable throughput scheduling indicates a peak throughput for an initial time period and a reduced throughput for a remaining time period in one or more scheduling intervals; and
transmit the one or more downlink transmissions in the one or more scheduling intervals according to the peak throughput for the initial time periods and the reduced throughput for the remaining time periods in the one or more scheduling intervals.

16. The network node of claim 15, wherein the information configuring the variable throughput scheduling comprises a downlink control information (DCI) message indicating one repetition and multiple slots for each of the one or more downlink transmissions.

17. The network node of claim 15, wherein the information configuring the variable throughput scheduling indicates the peak throughput according to a first frequency domain resource assignment (FDRA) and indicates the reduced throughput according to a second FDRA.

18. The network node of claim 17, wherein the first FDRA is a non-zero resource block (RB) allocation and the second FDRA is a zero RB allocation.

19. The network node of claim 18, wherein the zero RB allocation is indicated in an FDRA field in which every bit is set to zero or every bit is set to one.

20. The network node of claim 18, wherein the information that configures the variable throughput scheduling includes a slot offset indicator that indicates one or more slots associated with the non-zero RB allocation.

21. The network node of claim 15, wherein the information configuring the variable throughput scheduling indicates the initial time period according to a first start and length indicator value (SLIV) and indicates the remaining time period according to a second SLIV.

22. The network node of claim 21, wherein a value of the second SLIV is zero.

23. The network node of claim 15, wherein the information configures the variable throughput scheduling in association with an indication to switch a bandwidth part.

24. The network node of claim 15, wherein the information configures the variable throughput scheduling within a bandwidth part according to an offset, to the initial time period associated with the peak throughput, that satisfies a threshold related to tuning one or more of a baseband clock or a baseband voltage according to the peak throughput.

25. The network node of claim 15, wherein the information that configures the variable throughput scheduling indicates the remaining time period associated with the reduced throughput according to a time domain resource assignment (TDRA) associated with a skipping indication.

26. The network node of claim 25, wherein the TDRA is associated with a start and length indicator value (SLIV) and the skipping indication is indicated according to a quantity of slots after the SLIV that are associated with the reduced throughput.

27. The network node of claim 25, wherein the skipping indication is indicated according to a duration of time or a quantity of slots that remain in each of the one or more scheduling intervals after a start and length indicator value (SLIV) associated with the TDRA.

28. The network node of claim 15, wherein the processing system is further configured to cause the network node to:
receive feedback associated with the one or more downlink transmissions according to an offset from a last symbol of a last downlink transmission of the one or more downlink transmissions.

29. A method of wireless communication performed by a user equipment (UE), comprising:
receiving information that configures variable throughput scheduling for one or more downlink transmissions, wherein the information that configures the variable throughput scheduling indicates a peak throughput for an initial time period and a reduced throughput for a remaining time period in one or more scheduling intervals; and
receiving the one or more downlink transmissions in the one or more scheduling intervals according to the peak throughput for the initial time periods and the reduced throughput for the remaining time periods in the one or more scheduling intervals.

30. A method of wireless communication performed by a network node, comprising:
transmitting information that configures variable throughput scheduling for one or more downlink transmissions, wherein the information that configures the variable throughput scheduling indicates a peak throughput for an initial time period and a reduced throughput for a remaining time period in one or more scheduling intervals; and
transmitting the one or more downlink transmissions in the one or more scheduling intervals according to the peak throughput for the initial time periods and the reduced throughput for the remaining time periods in the one or more scheduling intervals.
